(19) United States
(12) Patent Application Publication
(10) Pub. No.: US 2009/0064994 A1
(43) Pub. Date: Mar. 12, 2009

(54) Concentrating solar collector

(76) Inventors: Clive Keith Weatherby, Reading (GB); Roger William Bentley, Bedfordshire (GB)

Correspondence Address: Ballard Spahr Andrews & Ingersoll, LLP, SUITE 1000, 999 PEACHTREE STREET, ATLANTA, GA, 30309-3915, US

(21) Appl. No.: 11/920,284

(22) PCT Filed: May 15, 2006
(86) PCT No.: PCT/GB2006/001776

§ 371 Date: Mar. 17, 2008

(30) Foreign Application Priority Data
May 13, 2005 (GB) 0509862.9

(51) Int. Cl. F24J 2/08; H02N 6/00

(52) U.S. Cl. 126/700; 136/246

(57) ABSTRACT

A concentrating solar collector comprises concentrating solar collector modules mounted on a frame. Each concentrating solar collector module comprises a trough with a lens sheet over its open face. The troughs each have a cross section that is substantially V shaped with a truncated (or flattened) base. The lens sheet incorporates a linear array of ten lenses in a row along its length. Each lens of the lens sheet is a circularly symmetric Fresnel lens. The concentrating solar collector modules can each rotate about a rocking axis parallel to their length. The concentrating solar collector modules can also rotate about a pitch axis substantially at their midpoints. This allows the lenses to track the position of the sun in the sky.

### FIELD OF THE INVENTION

This invention relates to a concentrating solar collector. In particular, the invention relates to a concentrating solar collector comprising multiple concentrating solar collector modules and to methods of manufacturing the same.

### BACKGROUND TO THE INVENTION

Concentrating solar collectors can be used to collect solar radiation for heating or electricity generation. In the case of electricity generation, they incorporate solar cells, which are able to convert solar radiation, or more plainly “light”, received at the concentrating solar collector into electricity. They are described as concentrating as they concentrate light onto the solar cells using lenses or mirrors. This reduces the area of solar cells needed to convert a given amount of light into electricity.

Given current interest in renewable sources of energy, there is a general desire to improve accessibility to solar electricity generation by making solar electricity generation cheaper. One route to this is cheaper solar collectors and the present invention is concerned with providing a solar collector having maximum electricity generation efficiency yet minimum manufacturing cost. In particular, there is a desire to use a minimum of manufacturing materials and for these materials to be cheap.

Furthermore, one particular problem associated with mounting solar cells in concentrating solar collectors arises from the need to dissipate heat away from the solar cells efficiently. Most of the energy of the light incident on solar cells is unfortunately absorbed as heat rather than converted into electricity due to the limited efficiency of the cells. Furthermore, most concentrating solar collectors that use lenses tend to trap heat, much like a greenhouse. As the solar cells heat up, they usually become less efficient. Operation at higher temperatures also tends to reduce the lifetime of the solar cells and other components of the concentrating solar collector. It is therefore desirable to dissipate heat from the solar cells and concentrating solar collector as efficiently as possible, but this can be difficult.

The present invention seeks to overcome these problems.

### SUMMARY OF THE INVENTION

According to a first aspect of the invention, there is provided a concentrating solar collector comprising multiple concentrating solar collector modules, each of the modules comprising a single row of roughly circularly symmetric lenses mounted along an open face of a trough in order to focus light incident on the lenses to discrete regions along the inside of the trough.

Similarly, according to a second aspect of the present invention, there is provided a method of manufacturing a concentrating solar collector comprising multiple concentrating solar collector modules, the method comprising forming each module by mounting a single row of substantially circularly symmetric lenses along an open face of a trough so that solar radiation incident on the lenses can be focused to discrete regions along the inside of the trough.

A concentrating solar collector having such concentrating solar collector modules has a number of advantages. In particular, the trough can have a comparatively large surface area per lens in comparison to a housing incorporating a two dimensional array of lenses. For example, if a module has a square cross section, the surface area of the each of the sides and base of the trough are each roughly the same as the surface area of all the lenses together. So, the surface area of the trough can be approximately three times the surface area of the lenses (ignoring the ends of the trough). On the other hand, for a housing of comparable depth incorporating a large two dimensional array of similar lenses, the surface area of the sides of the housing is small in comparison to the surface area of all of the lenses. So, the housing of such a large two dimensional array has almost the same surface area (that of its base) as the surface area of the lenses. One advantage of the invention is therefore that the concentrating solar modules can have a comparatively large ratio of total surface area to surface area of the lenses, which means that the concentrating solar collector can be significantly better at dissipating heat. Similarly, problems associated with thermal or humidity related expansion and contraction of the modules are alleviated by use of a single row of lenses rather than a two dimensional array, as only expansion and contraction along the length of the row has any significant effect. The trough also tends to be more rigid than a comparable housing for a two-dimensional array of lenses. It therefore requires less material or reinforcement to be sufficiently stiff to withstand wind loading and such like. This reduces manufacturing costs and can make the module lighter, which can improve portability and ease of installation. Increased stiffness can also reduce the accuracy with which the module needs to be aligned with the sun, as less stiff designs need to be aligned with the sun sufficiently accurately to tolerate variations in alignment of different lenses due to bending and twisting of the structure supporting them.

Solar cells should ideally be mounted at the regions along the inside of the trough at which the lenses focus the light. It will be appreciated that the lenses should continue to focus light to these regions regardless of the position of the sun in the sky. So, the concentrating solar collector modules are typically mounted so that they can rotate to track the azimuth and elevation of the sun in the sky. This tends to be simplest if the concentrating solar collector modules are arranged roughly parallel to one another.

For example, each concentrating solar collector module is usually mounted so that it can rotate around a rocking axis substantially parallel to its longitudinal axis. Preferably, the rocking axis of each concentrating solar collector module passes through the volume of the trough of the respective module. Most preferably, it is the major axis of the module. This allows the modules to each rotate separately and to be stably mounted. The solar collector modules are also usually mounted so that they can rotate around a pitch axis perpendicular to their longitudinal axes and in a direction from one side of the trough to another. The pitch axis usually substantially bisects the troughs of the solar collector modules, again allowing the modules to be stably mounted.

Rotation of the modules usually requires electrical power. The concentrating solar collector preferably therefore has a photovoltaic flat panel for generating electricity for use by the collector. The photovoltaic flat panel can be mounted on a dummy module. So, the solar collector may have a dummy module, of similar dimensions to the solar collector modules, for housing an apparatus for controlling rotation of the solar collector modules. The dummy module and the solar collector modules may have the same orientation and are arranged to rotate together, and the apparatus comprises a sensor for detecting the direction of the sun. The apparatus may also include a motor for driving the rotation of the solar collector modules.

The trough may have various shapes. It preferably has a uniform cross section. This cross section might be rectangular or square for example, so that the trough is box shaped. However, it is preferred that the trough is roughly V shaped in cross section. This increases the stiffness of the trough. The uniform cross section also allows the trough to be an extrusion. The method of manufacture may therefore include extruding the trough.

The lenses are usually Fresnel lenses, as these are relatively thin and lightweight in comparison to other types of lenses. This allows the row of lenses comprises a single sheet of material. However, in other examples, the lenses might be simple lenses, compound lenses, aspheric lenses, stepped lenses (such as Buffon lenses) or another form of light converging devices. They should be roughly circularly symmetric, as it is desirable for the concentrating solar collector to concentrate light to regions both toward a narrow part of the width of the trough and spaced apart from one another along the length of the trough. The regions are preferably spaced along the centre of the length of the base of the trough. Indeed, the regions are preferably at positions substantially coaxial with the axes of symmetry of the lenses. Similarly, the solar cells are preferably mounted on the inside surface of the base of the trough at positions substantially coaxial with the axes of symmetry of the lenses. Whilst any practical design that concentrates light to separate regions can be considered substantially circularly symmetric for the purpose of the invention, ideally the lenses are substantially or even exactly circularly symmetrical.

Typically, the concentrating solar collector module is incorporated in a solar collector with other similar concentrating solar collector modules. Indeed, the invention extends to a solar collector comprising more than one solar collector module described above. The concentrating solar collector modules are preferably arranged roughly parallel to one another in the solar collector.

Solar cells used in concentrating solar collectors are typically semiconductor devices fabricated as small discrete units. They usually have a light admitting top surface incorporating a top electrode and base incorporating a bottom electrode. When light is admitted by the top surface, a current can be generated between the top and bottom electrodes. Typically, a single solar cell can only produce a small amount of electricity. Several solar cells are therefore connected together in series via their top and bottom electrodes so that a useful amount of electricity can be generated.

Constructing the appropriate series circuit between the such solar cells in a concentrating solar collector is not straightforward. One difficulty is that the top and bottom electrodes are in different planes spaced apart from one another and facing in opposing directions. The electrical connections between the cells cannot usually therefore be in a single plane. Another difficulty arises from the need to place the solar cells in the concentrating solar collector at positions at which the collector concentrates incident light. These positions are typically spaced apart from one another over a two dimensional array and are dictated by the construction of the concentrating solar collector, or more specifically the position and concentrating characteristics of its lenses or mirrors. Arrangements for connecting and mounting the solar cells are often therefore complex. Usually, the solar cells are manually soldered into position in the collector and wires are soldered in place to form the desired series circuit, external contacts and such like. This is labour intensive and therefore slow and expensive.

So, it is preferred that the solar cells are provided on a solar cell assembly comprising:

a substrate having an electrically conducting layer divided into separate electrically conducting pads;

solar cells mounted on the substrate between respective adjacent pairs of the pads such that a bottom electrode on a bottom surface of each cell, facing the substrate, is in contact with one of the pads of the pair of pads between which the cell is mounted; and

electrically conducting tabs connecting a top electrode on a top surface of each cell, facing away from the substrate, to the other of the pads of the pair of pads between which the cell is mounted.

Similarly, it is preferred that the method of manufacturing the solar collector comprises providing the solar cells by using a solar cell assembly, manufacture of the solar cell assembly comprising:

dividing an electrically conducting layer of a substrate into separate electrically conducting pads;

mounting solar cells on the substrate between respective adjacent pairs of the pads such that a bottom electrode on a bottom surface of each cell, facing the substrate, is in contact with one of the pads of the pair of pads between which the cell is mounted; and

connecting electrically conducting tabs to a top electrode on a top surface of each cell, facing away from the substrate, to the other of the pads of the pair of pads between which the cell is mounted.

This significantly improves the ease with which the solar cell assembly can be manufactured. For example, the substrate can be a conventional electric circuit substrate material. This typically incorporates the electrically conducting layer on an electrically insulating layer. It is also usually flat with all layers parallel to one another. For example, the substrate might be a printed circuit board (PCB). PCBs typically have an electrically conducting layer of say copper bonded to an electrically insulating layer of say fibre glass. Alternatively, the substrate may be an integrated metal substrate (IMS) material. IMS materials typically comprise a metal base, such as aluminium, onto which a thin dielectric layer is bonded to provide the insulating layer. This tends to provide better thermal and electrical conductivity than a PCB. Most such electrical substrate materials are widely and cheaply available.

The electrically conducting layer, typically copper, on top of the insulating layer on most electrical circuit substrate materials can be divided into the electrically conducting pads easily. Typically, the dividing comprises applying a mask to the electrically conducting layer and etching the parts of the electrically conducting layer not covered by the mask, e.g. in an acid bath. So, the dividing may comprise etching. Such steps are commonly used in the manufacture of electronic components and therefore easy and cheap to implement using conventional manufacturing equipment. However, they have not been widely applied to the mounting of solar cells in concentrating solar collectors.

The tabs can straightforwardly connect the top electrodes of the solar cells to the respective other pads, despite the top electrodes usually being positioned above the pads due to the thickness of the solar cells. They can be shaped to extend between and contact the top electrodes of the solar cells and the respective other of the pair of pads when the solar cells are mounted on the substrate. Typically, they comprise a step. The tabs are typically formed into the appropriate shape in advance of beginning to be connected to the cells and pads. In other words, they are pre-shaped. Shaping the tabs in advance speeds up the connection process and simplifies manufacture. The connection usually comprises providing solder to any contact surfaces, e.g. of the pads, cells or tabs, and heating the assembly in a reflow oven (as does the mounting of the solar cells).

One tab is usually provided for each solar cell. In other words, the tabs are usually each in contact with just a single (other) pad and a single solar cell. This facilitates connection of the solar cells in series. However, other arrangements are possible, such as parallel connection of two or more solar cells using a single tab.

It can be useful for the solar cells to be positioned at various locations on the substrate. They are referred to as mounted on the substrate between respective adjacent pairs of pads. However, in this context, the term “between” is used loosely. The solar cells may overlap, and indeed preferably, overlap one or both of the pads and there is no requirement that the solar cells bridge the distance between the pads. So, the solar cells might equally be referred to as mounted on the substrate close to divisions between the pads or around intermediate points between the pads, for example. However, the solar cells are often placed along a straight line and spaced apart from one another. So, the pads may be arranged in a row. Similarly, the pads may be elongate (in a direction along the row). This can space the solar cells (mounted between the pads) apart from one another.

The solar cell assembly may have other components. For example, one or more bypass diodes may be provided to protect the solar cells against overload. An electrically conducting return path is usually provided to allow external contacts to the connected solar cells (or “cell string”) to be placed at one end of the assembly. A cover may be provided to protect the assembly. This typically comprises a laminate cover. The cover may substantially hermetically seal the assembly. This can reduce corrosion and increase the working lifetime of the assembly.

Preferred embodiments of the invention will now be described, by way of example only, with reference to the accompanying drawings.

### BRIEF DESCRIPTION OF THE DRAWINGS

FIG. 1 is a cut away schematic illustration of a concentrating solar collector according to a preferred embodiment of the invention;

FIG. 2 is a schematic illustration of a concentrating solar collector module of the solar collector illustrated in FIG. 1;

FIG. 3 is a close-up sectional view of the concentrating solar collector module shown in FIG. 2 along the line A-A.

FIG. 4 is a schematic illustration of a solar cell assembly of the concentrating solar collector module illustrated in FIGS. 2 and 3; and

FIG. 5 is an exploded view of the solar cell assembly illustrated in FIG. 4.

### DETAILED DESCRIPTION OF THE PREFERRED EMBODIMENTS

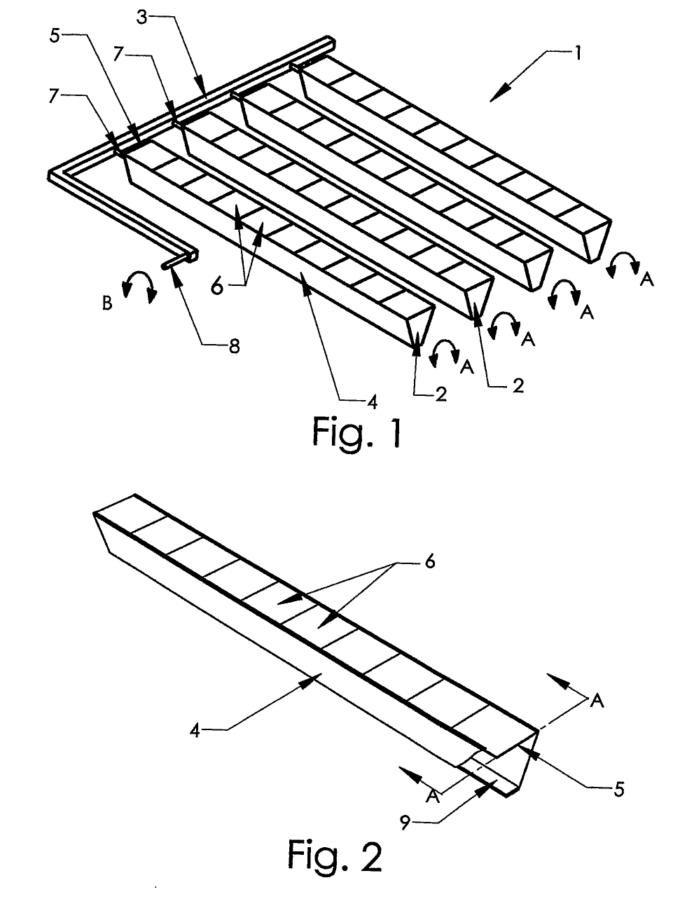

Referring to FIG. 1, a concentrating solar collector 1 comprises concentrating solar collector modules 2 mounted on a frame 3. The number of concentrating solar collector modules 2 can vary. The concentrating solar collector I is shown in FIG. 1 with four concentrating solar collector modules 2, but the collector 1 can have more or less than four modules 2 in other embodiments. Indeed, typically the concentrating solar collector 1 has around twelve concentrating solar collector modules 2.

Each concentrating solar collector module 2 comprises a trough 4 with a lens sheet 5 over its open face. The troughs 4 are roughly V shaped. More specifically, the troughs 4 each have a cross section that is substantially V shaped with a truncated (or flattened) base. In other words, the troughs 4 are narrower at their base than at their open face. This can help to make the troughs 4 more rigid than comparable box or U shaped designs. The troughs 4 also have a uniform cross section along their length, which allows them to be extrusions. The troughs 4 are aluminium in this embodiment, as this can be easily extruded. In contrast, the frame 3 is steel, as it is strong and easily welded into the desired shape.

The lens sheet 5 incorporates ten lenses 6 in a row along its length. It might be described as a linear array of lenses 6. Again, the lens sheet 5 may have more or less lenses 6 in other embodiments. Typically, the lenses 6 each have a diameter between 8 and 15 cm. The lens sheet 5 is made from polymethylmethacrylate in this embodiment, but it can alternatively be made from a variety of other suitable materials, such as polycarbonate, silicone compounds, polyethylene terephthalate (PET) or glass. Each lens 6 of the lens sheet 5 is a circularly symmetric Fresnel lens. In other words, each lens 6 comprises a pattern of concentric rings on the lens sheet 5, with rings of increasing diameter having profiles that cause incident light to bend by greater angles, such that light passing through each lens 6 is focused substantially to a single respective point.

The concentrating solar collector modules 2 are mounted on the frame 3 by spindles 7 fixed to the troughs 4, but free to rotate about their axes in the frame 3. Each concentrating solar collector module 2 has a spindle 7 positioned at each end of its trough 4, oriented such that its axis of rotation is parallel to the longitudinal axis of the module 2, although only the spindles 7 at one end of the modules are shown in the cut away view of FIG. 1. So, the concentrating solar collector modules 2 can each rotate about a rocking axis parallel to their length, e.g. in the direction of arrows A in FIG. 1. In other words, they can rock from side to side. In this embodiment, the rocking axes of the concentrating solar collector modules 2 are their respective major axes.

The frame 3 is mounted on a base (not shown) by axles 8 fixed to the frame 3, but free to rotate about the axis defined by the axles 8 in the base, e.g. in the direction of arrow B in FIG. 1. Again, only one axle 8 is shown in the cut away view of FIG. 1, but the frame 3 is actually rectangular and another axle 8 is mounted on the frame 3 coaxially with the shown axle 8 but on the opposite side of the frame 8. The axles 8 are substantially perpendicular to the spindles 7 and parallel to the major plane defined by the solar collector modules 2 (and hence the lenses 6). In this embodiment, the axis defined by the axles 8 substantially bisects the lengths of the solar collector modules 2. So, the concentrating solar collector modules 2 can rotate about a pitch axis substantially at their midpoints.

The plane of the lenses 6 can therefore be tilted in any direction by amounts determined by the range of rotation of the spindles 7 and axle 8. In this embodiment, the base is oriented so that the spindles 7 can rotate to vary the azimuth of the direction in which the lenses 6 face. In other words, they can allow the lenses 6 to track the sun from east to west. Likewise, the axle 8 is oriented such that it can vary the elevation of the direction in which the lenses 6 face. In other words, it can allow the lenses 6 to track the height of the sun in the sky.

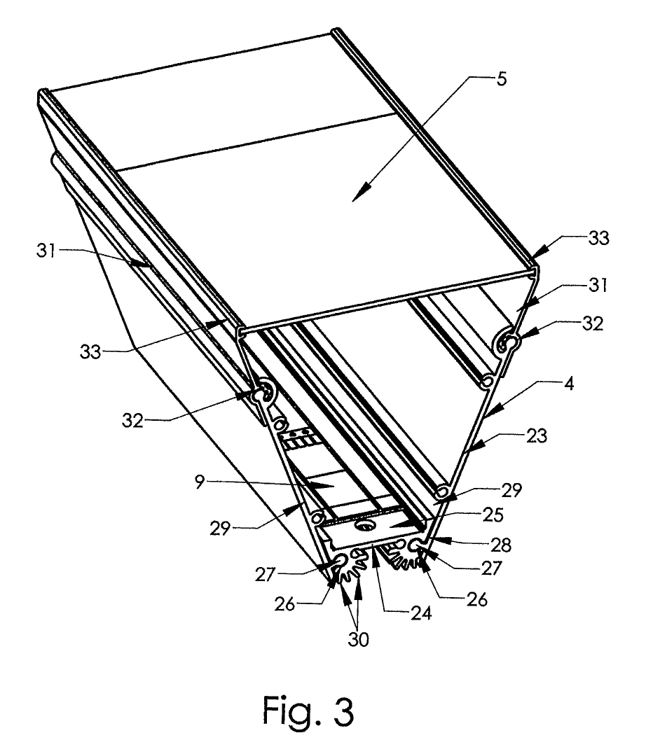

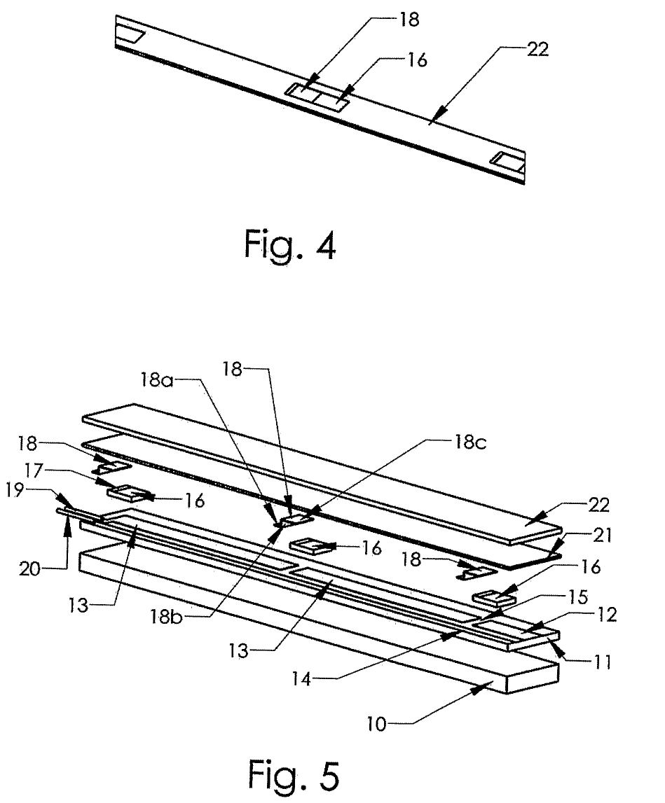

Referring to FIGS. 2 to 5, the concentrating solar collector modules 2 each house a solar cell assembly 9. In some embodiments, the trough 4 is a single, integrally formed unit and the solar cell assembly 9 is mounted on the inside surface of the base of the trough 4. However, in the illustrated embodiment, the trough 4 comprises several separately formed components joined to one another. More specifically, the trough 4 comprises two lower side walls 23 mounted on either side of a base 24. The lower side walls 23 and base 24 are extruded and therefore have uniform cross section along their length. In this embodiment, they are aluminium. The base 24 has a flat surface 25 upon which the solar cell assembly 9 can be mounted. To either side of the flat surface 25, the base 24 has a groove 26 for accommodating respective tongues 27 of the lower side walls 23. This tongue and groove arrangement is used to secure the lower side walls 23 to the base 24.

The grooves 26 open onto side surfaces 28 of the base 24 inclined with respect to the flat surface 25 of the base 24 on which the solar cell assembly 9 can be mounted. The inclined side surfaces 28 are arranged to be flush with inside surfaces 29 of the lower side walls 23 when the tongues 26 of lower side walls 23 are positioned in the grooves 25 of the base 24. So, the angle of inclination of the side surfaces 28 to the flat surface 25 of the base 24 defines the angle of the inside surfaces 29 of the lower side walls 23 to the flat surface 25 of the base 24. As mentioned above, in this embodiment, the trough 4 has a substantially V shaped cross section. So, the side surfaces 28 are inclined obtusely to the flat surface 25 of the base 24 in a direction toward the open face of the trough 4. The underside of the base 24 incorporates fins 30 that increase the surface area of the base and assist with heat dissipation.

Upper side walls 31 are provided adjacent the open face of the trough 4 between the lower side walls 23 and the lens sheet 5. The upper side walls 31 are formed of a plastics material. They are each joined to the lower side walls using another interlocking tongue and groove joint 32, incorporating an o ring seal (not shown) to reduce the likelihood of water and dust getting inside the module 2 through the joint 32. The incorporation of upper and lower side walls 31, 23 allows the trough 4 to maintain structural rigidity, but keeps the weight of the trough 4 to a minimum and allows lateral expansion and contraction of the module 2 to be accommodated. In particular, joints 33 between the trough 4 and the lens sheet 5 are put under less stress during thermal expansion and contraction due to the presence of the plastics, and hence relatively flexible, upper side walls 31 and the joints 32 between the upper side walls 31 and lower side walls 23.

The solar cell assembly 9 comprises a strip of integrated metal substrate material. More specifically, the solar cell assembly 9 has a substrate comprising a base layer 10 of aluminium, an insulating layer 11 of dielectric material on the base layer 10 and an electrically conducting layer 12 of copper on the insulating layer 11. The electrically conducting layer 12 is divided into electrically conducting pads 13. This is achieved by applying a masking material to the electrically conducting layer 12 to cover the areas of the layer 12 that make up the pads 13 and any other required connections or components and then etching the exposed areas of the electrically conducting layer 12, e.g. in an acid bath. The electrically conducting pads 13 are elongate and arranged in a row along the same direction as their length, which is along the length of the assembly 9. Another part of the electrically conducting layer 12 forms an electrically conducting return path 14 beside the row of electrically conducting pads 13.

The electrically conducting pads 13 are arranged along the row with gaps 15 between them. Approximately at each gap 15, a solar cell 16 is mounted on the substrate. The solar cells 16 may be of virtually any type. They might also be referred to as photovoltaic (PV) cells. However, they are typically buried grid PV cells around 1 cm to 2 cm across and each have a top electrode 17 on their top surface, e.g. the surface facing away from the substrate (which is also the surface onto which light is directed by the lenses 6) and a bottom electrode (not shown) on their bottom surface, e.g. the surface facing toward the substrate. The top electrodes 17 are, in this embodiment, positioned at one end of the solar cells 16. It is not required that the top electrode 17 is limited to this position. Indeed, it is usually preferable for the top electrode 17 to broadly cover the top surface of the solar cell 16, provided light can pass through the electrode 17 or through gaps in the electrode 17. However, it is useful for the purpose of the invention that full electrical contact can be made with the top electrode 17 from the end of the top surface of the solar cell 16. The bottom electrode may extend over the whole of the base of the solar cell 16. Indeed, the bottom electrode is often the base of the solar cell 16.

Each solar cell 16 is mounted on the substrate such that its bottom electrode is in contact with only one of the electrically conducting pads 13 adjacent the gap 15 at which it is positioned. In this embodiment, this is achieved by offsetting the solar cells 16 from their respective gap 15 so that they overlap only one of the electrically conducting pads 13. In another embodiment, an insulating insert or such like is used to shield the other electrically conducting pad 13 from the bottom electrode of the solar cell 16.

Electrically conducting tabs 18 are provided for connecting the top electrodes 17 of the solar cells 16 to the other electrically conducting pad 13 of the pair of pads 13 adjacent the gap 15 at which the respective solar cell 16 is positioned. The electrically conducting tabs 18 comprise steps of electrically conducting material, which in this embodiment is copper. More specifically, each tab 18 has a bottom plate 18a, a riser 18b and a top plate 18c. The riser 18b has roughly the same height as the thickness of the solar cell 16. The riser 18b is placed near the edge of the solar cell 16 at the end of the solar cell 16 at which the top electrode 17 is located. Generally, the riser 18b is not in contact with the edge of the solar cell 16, to avoid any possibility of direct contact with the bottom electrode of the cell 16, which would create a short circuit across the cell 16. The top plate 18c of the tab 18 extends sufficiently far from the riser 18b to reach across the contact area of the top electrode 17 of the solar cell 16, but not over a light receiving portion of the top surface of the cell 16. The bottom plate 18a extends sufficiently far from the riser 18b (in the opposite direction to the top plate 18c) to contact the other electrically conducting pad 13 of the pair of pads 13 at which the solar cell 13 is located, with the solar cell 13 positioned so that its bottom electrode is in contact with the one pad 13 of the pair of pads 13, as described above. So, a series connection is made from the one electrically conducting pad 13 to the bottom electrode of the solar cell 16, through the solar cell 16 to the top electrode 17 of the solar cell 16, and from the top electrode 17 to the other pad 13 via the top plate 18c, riser 18b and bottom plate 18a of the electrically conducting tab 18. With each solar cell 16 arranged in this way, the cells 16 are connected to one another in series by the pads 13 and tabs 18.

External contacts 19, 20 allow the series of solar cells 16 to be connected to a load or such like outside the cell assembly 9. More specifically, a first external contact 19 is connected to a pad 13 at a proximate end of the row of pads 13, e.g. proximate to the external contacts 19, 20. A second external contact 20 is connected to the electrically conducting return path 14, which is in turn connected to a pad 13 at a distal end of the row of pads 13, e.g. distal to the external contacts 20.

In this embodiment, each solar cell assembly 9 has two circuits. More specifically, half of the solar cells 16 of a respective solar cell assembly 9 are connected in a first series circuit and the other half of the solar cells 16 are connected in a second series circuit. The solar cells 16 of the two circuits are next to one another. In other words, the first circuit connects the cells 16 toward one end of the assembly 9 and the second circuit connects the cells 16 toward the other end of the assembly. This has the advantage that the solar cell assembly 9 has a greater output when one end of the assembly is shaded, e.g. as might happen when the sun is low in the sky.

Whilst only a single circuit is illustrated in FIG. 5, it should be understood in particular that the solar cell assembly 9 has a first set of external contacts 19, 20 for the first circuit and a second set of external contacts 19, 20 for the second circuit. All these contacts are led to one end of the solar cell assembly 9 and connected through the end of the trough 4 to an output for the solar collector 1. Electrical connections into each module 2 are led through the end of the trough to avoid shading the solar cells 16 and to minimise exposure of the connections (e.g. electrical cables or such like) sunlight, thus reducing degradation that can be caused by Ultra Violet (UV) light.

The solar cell assembly 9 also has a cover to slow corrosion of the pads 13, solar cells 16, tabs 18 etc. In this embodiment, the cover comprises a transparent seal 21 and a transparent cover sheet (or film) 22. The seal 21 and cover sheet 22 make up a laminate that substantially hermetically seals pads 13, solar cells 16, tabs 18 etc on top of the base layer 10 of the substrate.

In its assembled state, it will be appreciated that the solar collector 1 requires means to drive rotation of the solar collector modules 2. So, in this embodiment, one of the solar collector modules 2 is actually a dummy module (not shown). This dummy module has the same dimensions as the other solar collector modules 2 and is mounted on the frame 3 in the same way. However, rather than housing a solar cell assembly 9, the dummy module houses an apparatus from controlling the rotation of the solar collector modules 2 (and itself). More specifically, the dummy module houses a sensor for detecting the orientation of the sun. The output of the sensor is used to ensure that the modules 2 point directly at the sun, e.g. the direction of the sun from the collector 1 is normal to the planes of the lens sheets 5, all day. In addition to the sensor, the apparatus comprises control electronics and a battery for providing electrical power to the apparatus and to drive the rotation of the modules. It also comprises a motor (not shown). The motor is arranged to rotate the dummy module about its spindle 7. Furthermore, a mechanical linkage (not shown) joins the dummy module to the solar collector modules 2 and, as the motor causes the dummy module to rotate, the mechanical linkage causes the solar collector modules 2 to rotate in a similar way. All the modules rotate together, by the same degree. Means is also provided to cause the modules to rotate about the axles 8. In one embodiment, this comprises a hooped track (not shown) mounted on one of the axles 8 and driven by rollers (not shown). In another embodiment, the axle 8 has a cog (not shown) and a toothed belt (not shown) is used to drive the cog. The control electronics and battery of the dummy module control the rollers or toothed belt as appropriate. The main advantage of housing as much of the control apparatus as possible in a dummy module is that it allows easy replacement of the control apparatus in the event of failure.

Naturally, the battery has limited power. A PV flat panel (not shown) is therefore provided to charge the battery. This PV flat panel is also mounted on the dummy module, for example by forming part of a dummy lens sheet for the dummy module. Importantly, a PV flat panel can produce electricity even when not pointed directly at the sun, so power can be provided to the solar collector 1 even when it is incorrectly aligned, thus allowing realignment of the solar collector 1.

The described embodiments of the invention are only examples of how the invention may be implemented. Modifications, variations and changes to the described embodiments will occur to those having appropriate skills and knowledge. These modifications, variations and changes may be made without departure from the spirit and scope of the invention defined in the claims and its equivalents.

1. A concentrating solar collector comprising multiple concentrating solar collector modules, each of the modules comprising a single row of substantially circularly symmetric lenses mounted along an open face of a trough in order to focus light incident on the lenses to discrete regions along the inside of the trough.

2. The concentrating solar collector of claim 1, wherein the concentrating solar collector modules are arranged roughly parallel to one another.

3. The concentrating solar collector of claim 1, wherein the concentrating solar collector modules are mounted so that they can rotate to track the azimuth and elevation of the sun in the sky.

4. The concentrating solar collector of claim 1, wherein the concentrating solar collector modules are each mounted so that they can rotate about a rocking axis substantially parallel to their respective longitudinal axes.

5. The concentrating solar collector of claim 4, wherein the rotation about the rocking axis allows the solar collector modules to track the azimuth of the sun in the sky.

6. The concentrating solar collector of claim 1, wherein the concentrating solar collector modules are each mounted so that they can rotate around a pitch axis substantially perpendicular to their respective longitudinal axes.

7. The concentrating solar collector of claim 6, wherein the rotation about the pitch axis allows the solar collector modules to track the elevation of the sun in the sky.

8. The concentrating solar collector of claim 1, having a photovoltaic flat panel for generating electricity for use by the collector.

9. The concentrating solar collector of claim 8, wherein rotation of the solar collector modules is powered by the photovoltaic flat panel.

10. The concentrating solar collector of claim 1, having a dummy module, of similar dimensions to the solar collector modules, for housing an apparatus for controlling rotation of the solar collector modules.

11. The concentrating solar collector of claim 10, wherein dummy module and the solar collector modules have the same orientation and are arranged to rotate together, and the apparatus comprises a sensor for detecting the direction of the sun.

12. The concentrating solar collector of claim 10, wherein the apparatus includes a motor for driving the rotation of the solar collector modules.

13. The concentrating solar collector of claim 1, wherein the trough is roughly V shaped in cross section.

14. The concentrating solar collector of claim 1, wherein the trough is an extrusion.

15. The concentrating solar collector of claim 1, wherein solar cells are mounted on the inside surface of the base of the trough at positions substantially coaxial with the axes of symmetry of the individual lenses.

16. The concentrating solar collector of claim 1, wherein the lenses are Fresnel lenses.

17. The concentrating solar collector of claim 1, wherein the row of lenses comprises a single sheet of material.

18. The concentrating solar collector of claim 1, wherein (the) solar cells are provided in the concentrating solar collector modules such that electricity generated by a group of solar cells toward one end of a respective module can be extracted without passing through a group of solar cells toward the other end of the module.

19. The concentrating solar collector of claim 1, wherein solar cells are provided in the concentrating solar collector modules by a solar cell assembly, the solar cell assembly comprising:
a substrate having an electrically conducting layer divided into separate electrically conducting pads;
solar cells mounted on the substrate between respective adjacent pairs of the pads such that a bottom electrode on a bottom surface of each cell, facing the substrate, is in contact with one of the pads of the pair of pads between which the cell is mounted; and
electrically conducting tabs connecting a top electrode on a top surface of each cell, facing away from the substrate, to the other of the pads of the pair of pads between which the cell is mounted.

20. The concentrating solar collector of claim 19, wherein the substrate has an electrically insulating layer on which the electrically conducting layer lies.

21. The concentrating collar collector of claim 19, wherein the substrate is a printed circuit board.

22. The concentrating collar collector of claim 19, wherein the substrate is an integrated metal substrate material.

23. The concentrating collar collector of claim 19, wherein the tabs each comprise a step from the other of the pads to the top electrode.

24. The concentrating collar collector of claim 19, wherein the tabs are pre-formed.

25. The concentrating collar collector of claim 19, wherein the solar cells are connected together in series by the pads and tabs.

26. The concentrating collar collector of claim 19, wherein the solar cells are arranged in a substantially straight line.

27. The concentrating collar collector of claim 19, further comprising one or more bypass diodes connected in parallel with the solar cells.

28. The concentrating collar collector of claim 19, further comprising a laminate cover.

29-60. (canceled)
